(19) United States
(12) Patent Application Publication
(10) Pub. No.: US 2023/0109308 A1
(43) Pub. Date: Apr. 6, 2023

(54) INK COMPOSITION FOR INKJET PRINTING

(71) Applicant: DOMINO UK LIMITED, Trafalgar (GB)

(72) Inventors: Lisa Verena Schindler, Cambridge Cambridgeshire (GB); Henry Solomon Mbuthia Kimani, Cambridge Cambridgeshire (GB); Olivier Jean-Louis Xavier Morel, Cambridge Cambridgeshire (GB)

(21) Appl. No.: 17/909,741

(22) PCT Filed: Mar. 5, 2021
(86) PCT No.: PCT/EP2021/055655

§ 371 Date: Sep. 6, 2022

(30) Foreign Application Priority Data
Mar. 6, 2020 (GB) 2003258.7

(51) Int. Cl. C09D 11/104; C09D 11/08; C09D 11/033

(52) U.S. Cl. CPC C09D 11/104; C09D 11/08; C09D 11/033

(57) ABSTRACT

Provided is an ink composition, in particular an inkjet ink composition for use in inkjet printing such as drop on demand inkjet printing or continuous inkjet printing, which is suitable for producing codes on non-porous substrates. The ink composition has a C₁₋₆ alcohol solvent, a C₃₋₁₂ ester solvent, a siloxane surfactant, and a capping resin selected from a rosin resin and a terpene phenolic resin. The ink compositions have short drying times in combination with long decap times and/or good latency.

### RELATED APPLICATION

The present case claims priority to, and the benefit of, GB 2003258.7 filed on 6 Mar. 2020 (06/03/2020), the contents of which are hereby incorporated by reference in their entirety.

### FIELD OF THE INVENTION

The present invention relates to an ink composition, in particular an ink composition for use in inkjet printing, such as drop on demand inkjet printing.

### BACKGROUND OF THE INVENTION

In the field of industrial coding and marking codes, dating and traceability information are applied directly onto products and/or packaging. Such marking is often performed using printers, such as inkjet printers.

Forming codes, images or characters on non-porous substrates, such as those commonly used in food packaging, with inkjet printing requires the drops of ink ejected from the printer to be ‘frozen’ on the substrate shortly after impact. Freezing the drops quickly allows the codes, images or characters to be formed of a controlled series of coalesced or non-coalesced well defined drops. Thus, freezing is required to provide accurate images.

It is therefore desirable to provide an ink composition that exhibits rapid drying when printed to freeze the image on the substrate.

There are several known ways to freeze dots on a non-porous substrate including UV curing that triggers polymerisation inside the ink droplet or dot, providing specific inkjet substrates or heating the substrate.

The ‘UV curing’ method requires the presence of curable monomers and specific conditions to be employed. This methods requires additional equipment and specific components.

The ‘inkjet substrate’ method requires specific substrates, typically a substrate with a highly absorptive layer, which physically absorbs the ink droplets or a substrate with a chemically reactive layer which is specifically chosen to react with a component present in the ink, (e.g. see U.S. Pat. No. 6,652,085 & U.S. Pat. No. 7,066,590). These methods require a specific extra layer (either porous or reactive) to be applied to the substrate and specific ink components.

The ‘heated substrate’ method requires the substrate to be printed is heated during the printing process typically to temperatures in the 40 to 70° C. range. Once the drop hits the substrate there is a decrease in viscosity and evaporation of the volatile components causing higher solid concentration in the ink and a fast increase in ink viscosity. This method requires additional equipment to heat the substrate and, particularly at high printing rates, this heating can negatively affect the print head.

Fast drying inks typically do not require additional equipment or steps to be performed in order to provide high quality printing, particularly high quality printing on non-porous packaging. However, there are a number of issues created by inks which dry quickly. For example, increasing the drying rate of the ink on the substrate increases the evaporation rate of the ink at the aperture in the cartridge or the printer nozzle.

Decap refers to the time that nozzles can be uncovered and idle before they will no longer print. The decap time is the printer idle time after which maintenance will be necessary to regain the print quality. Decap time can also be referred to as “open time”.

Latency refers to the time that nozzles can be left inactive during a print session before there is a significant reduction in initial performance when printing is active. For example latency refers to the time between printing during a print session after which the first few drops are either irregular or are not printed. Often, latency problems produce ragged edges in images and can be referred to as a first drop problem. Latency can also be referred to as “dwell time”.

It is desirable for inks for coding and marking to have short drying times in combination with long decap times and good latency.

It is an object of the present invention to provide an ink composition that has at least some of the above desirable characteristics. In particular, it is an object of the invention to provide an ink which exhibits fast drying in combination with long decap times and good latency.

It is an alternative and/or additional object of the present invention to overcome or address the problems of prior art inkjet ink compositions or to at least provide a commercially useful alternative thereto.

### SUMMARY OF THE INVENTION

The present invention seeks to provide an ink composition, in particular an ink composition for use in inkjet printing such as a drop on demand inkjet printing, which is suitable for producing codes on non-porous substrates and has short drying times in combination with long decap times and/or good latency. The inks of the present invention may also provide good end user properties such as adhesion and/or good print quality.

Accordingly, in one aspect the present invention provides an ink composition comprising a C₁₋₆ alcohol solvent, a C₃₋₁₂ ester solvent, a siloxane surfactant, and a capping resin selected from a rosin resin and a terpene phenolic resin.

In another aspect the present invention provides a printed deposit formed from the ink composition of the invention. The printed deposit comprises the capping resin and the siloxane surfactant. The printed deposit may contain trace amounts of the solvents.

In this way, the ink formulations of the invention provide fast drying solvent based ink formulations with good decap and/or latency properties along with good end user properties such as adhesion or image accuracy (e.g. high grade barcode images) and/or good print quality such as high image accuracy.

Without wishing to be bound by theory it is proposed that the combination of a capping resin, a siloxane surfactant and an ester solvent in the ink work by forming a temporary cap at the nozzle or cartridge aperture. The temporary cap prevents or significantly reduces evaporation of the alcohol solvent when the ink is loaded in the printer. The temporary cap may also prevent unwanted evaporation of the solvent during printing, such as during continuous inkjet printing, when the ink droplet is moving through the air or being recovered by the gutter. When printed, the ink still has sufficient alcohol solvent to provide fast drying to freeze the image on the substrate. Thus, the temporary cap provided by the components of the ink may provide extended latency time and/or good decap properties while maintaining fast drying times on the substrate.

The ink composition is compatible with the components of an inkjet printer such as a drop on demand inkjet printer or a continuous inkjet printer (CIJ). Preferably, the ink is suitable for use in a drop on demand (DOD) inkjet printer such as a thermal inkjet (TIJ) printer. The ink composition is suitable for application directly onto products and/or product packaging to achieve high quality images.

These and other aspects and embodiments of the invention are described in further detail below.

### SUMMARY OF THE FIGURES

FIG. 1 shows an example of the dry time test at 150×600 dpi (top) and 200×300 dpi (bottom) on a sheen card substrate, Hiding Power Chart, 301-A, coated supplied by TQC sheen with the Formulation no. 11 in Example 2.

FIG. 2 shows an example of the latency test with the Formulation no. 11 in Example 2.

FIG. 3 shows a test message printed using Formulation no. 11 of Example 2 at 200×300 dpi for adhesion testing.

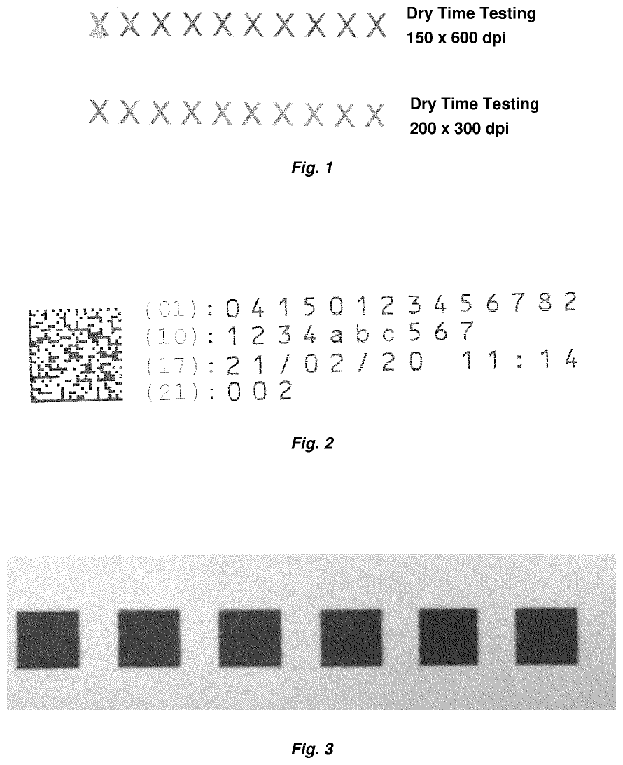

### DETAILED DESCRIPTION OF THE INVENTION

The present invention provides an ink composition having a C₁₋₆ alcohol solvent, a C₃₋₁₂ ester solvent, a siloxane surfactant, and a capping resin selected from a rosin resin and a terpene phenolic resin.

It is proposed that the combination of a capping resin, siloxane surfactant and ester solvent in the ink work by forming a temporary cap at the nozzle or cartridge aperture. Further, without being bound by theory it is proposed that the capping resin is transported by the siloxane surfactant to the air-ink interface at the nozzle or cartridge aperture. It is proposed that the hydrophobic groups of the siloxane surfactant interact with the hydrophobic functional groups of the capping resin, accumulating on the ink-air interface. The hydrophilic groups of the siloxane surfactant interact with the bulk solvent which is the C₁₋₆ alcohol. It is also proposed that the resin is solubilised by the ester solvent during transport to the air-ink interface. The capping resin, siloxane surfactant and ester solvent form a barrier at the air-ink interface.

Without wishing to be bound by theory, the siloxane surfactant may secure the capping resin by interaction with oxygen groups in the resin. In some cases the siloxane surfactant may have a branched structure that provides multiple interactions with the capping resin. The ester solvent solubilises the capping resin. As the capping resin moves to the ink-air interface the ester solvent is transported by the surfactant. The ester solvent typically may have a lower evaporation rate than the alcohol solvent and so has no or limited evaporation at the interface and helps provide the temporary cap which reduces or prevents the alcohol solvent evaporating. In this way, it is proposed that the capping resins and siloxane based surfactant claimed provide extended latency.

U.S. Pat. No. 9,957,401 B2 discloses inks having an organic solvent, a resin, a surfactant and a colorant. The aim of the patent is to improve decap time and it is proposed that the use of a surfactant does this by organising at the air-ink interface to prevent solvent evaporating. It is explained that the resin provides the ink with the required viscosity and adhesion. U.S. Pat. No. 9,957,401 B2 does not disclose the specific combination of solvents, surfactants and resins required in the present invention. Also, using the drying test method discussed below and used to test the inks of the present invention, i.e. 150×600 dpi ink laydown, the drying time of the formulation in U.S. Pat. No. 9,957,401 B2 is >2s.

Preferably the ink composition described herein has a viscosity of about 0.5 to 25 mPa·s, more preferably from 1 to 22 mPa·s at 25° C. Preferably the ink composition described herein has a viscosity of less than 25 mPa·s, more preferably less than 22 mPa·s at 25° C. Preferably the ink composition described herein has a viscosity of greater than 0.5 mPa·s, more preferably greater than 1 mPa·s, even more preferably greater than 2 mPa·s at 25° C. The viscosity of the ink composition may be in a range with the upper and lower limits selected from the amounts described above. The viscosity of the composition may be measured using a viscometer such as a Brookfield DV-II+ viscometer.

Preferably the ink composition as described herein has a surface tension of from 20 to 50 mN/m, more preferably from 21 to 25 mN/m at 24° C. The surface tension of the composition may be measured using equipment such as a SITA bubble pressure tensiometer. The bubble life time may be around 20 seconds.

The ink composition may also contain water. For example, if present, water may be present at less than 10 wt % based the total weight of the ink composition, preferably water is present at less than 5 wt % or less than 1 wt %.

The ink composition may be a non-aqueous composition.

C₁₋₆ Alcohol Solvent

The ink composition of the present invention comprises a C₁₋₆ alcohol solvent. The C₁₋₆ alcohol solvent may be a single C₁₋₆ alcohol solvent or a mixture of two or more C₁₋₆ alcohol solvents. Preferably the C₁₋₆ alcohol solvent is a mixture of two or more C₁₋₆ alcohols, more preferably the C₁₋₆ alcohol solvent is mixture of exactly two C₁₋₆ alcohols.

It is proposed that the C₁₋₆ alcohol solvent provides short drying times due to quick evaporation.

The drying time of the ink varies depending on the ambient temperature, pressure and humidity as well as on the amount of ink laid down, i.e. resolution. Preferably the ink dries in from 0.1 to 3 seconds at 22° C., 1.013 kPa and 40% humidity when printed at 200×300 dpi.

The drying time may be measured by printing a number of separate characters simultaneously on a sheen card or Melinex substrate and rubbing one character in fixed intervals, such as 1 second intervals, starting immediately after printing. The drying time is the time taken for the ink to cease smearing when rubbed.

The C₁₋₆ alcohol solvent may be selected from ethanol, isopropanol, n-propanol, isobutanol, n-butanol, cyclohexanol, cyclopentanol, ethylene glycol, propylene glycol, 1-methoxy-2-propanol or mixtures thereof.

Preferably the C₁₋₆ alcohol solvent is selected from ethanol, 1-methoxy-2-propanol or mixtures thereof. More preferably, the C₁₋₆ alcohol solvent is a mixture of ethanol and 1-methoxy-2-propanol.

The C₁₋₆ alcohol solvent may be present in less than 95 wt % based on total weight of the ink composition, preferably less than 90 wt % and more preferably less than 87 wt %.

The C₁₋₆ alcohol solvent may be present in greater than 10 wt % based on total weight of the ink composition, preferably greater than 40 wt %, and more preferably greater than 70 wt %. For example, the C₁₋₆ alcohol solvent may be present in greater than 45 wt %, greater than 50 wt %, greater than 55 wt %, greater than 60 wt % or greater than 65 wt % C₁₋₆ alcohol solvent

The C₁₋₆ alcohol solvent may be present in an amount that is in a range with the upper and lower limits selected from the amounts described above. For example, the C₁₋₆ alcohol solvent may be present in the composition between 10 to 95 wt %, preferably 40 to 90 wt %, and most preferably 70 to 90 wt % by weight based on total weight of the ink composition.

In the printed deposit the C₁₋₆ alcohol solvent has at least partially evaporated. In this case, it may be that no C₁₋₆ alcohol solvent or only trace amounts of C₁₋₆ alcohol solvent are present in the printed deposit.

The C₁₋₆ alcohol solvent may have a higher evaporation rate than the C₃₋₁₂ ester solvent.

The C₁₋₆ alcohol solvent has an evaporation rate of less than 4, preferably less than 2. The evaporation rate is measured relative to N-butylacetate. The evaporation method may be measured by the ASTM method D3539-87(2004), Standard Test Methods for Evaporation Rates of Volatile Liquids by Shell Thin-Film Evaporometer, ASTM International, West Conshohocken, Pa., 2004.

The C₁₋₆ alcohol solvent may have a lower boiling point than the C₃₋₁₂ ester solvent.

The C₁₋₆ alcohol solvent may have a boiling point of 200° C. or less at 1.0 bar pressure, preferably 150° C. or less, more preferably 120° C. or less and even more preferably 100° C. or less.

The C₁₋₆ alcohol solvent may have a boiling point of 45° C. or more at 1.0 bar pressure, preferably 50° C. or more and more preferably 60° C. or more.

The C₁₋₆ alcohol solvent may have a boiling point in a range with the upper and lower limits selected from the amounts described above. For example, the C₁₋₆ alcohol solvent may have a boiling point between 60 and 120° C. at 1.0 bar pressure.

When the C₁₋₆ alcohol solvent is a mixture the boiling point refers to the individual boiling point of at least one of the C₁₋₆ alcohols in the mixture, preferably, the boiling point refers to the individual boiling point of all of the C₁₋₆ alcohols in the mixture. The term individual boiling point used here refers to the boiling point of the solvent measured when the solvent is not in a mixture.

When the C₁₋₆ alcohol solvent is a mixture of two solvents one C₁₋₆ alcohol solvent will have a lower boiling point than the other C₁₋₆ alcohol solvent in the mixture. The ratio of the C₁₋₆ alcohol solvent with the higher boiling point to the C₁₋₆ alcohol solvent with the lower boiling point by weight may be from 1:1.1 to 1:2.5, preferably from 1:1.2 to 1:2.1.

The ratio of the C₁₋₆ alcohol solvent to the C₃₋₁₂ ester solvent may be from 90:1 to 70:10, preferably from 90:1 to 70:5.

C₃₋₁₂ Ester Solvent

The ink composition of the present invention comprises a C₃₋₁₂ ester solvent. The C₃₋₁₂ ester solvent may be a single C₃₋₁₂ ester solvent or a mixture of two or more C₃₋₁₂ ester solvents.

It is proposed that the C₃₋₁₂ ester solvent solubilises the resin during transport of the resin to the air-ink interface.

The C₃₋₁₂ ester solvent may be selected from ethyl acetate, propyl acetate, butyl acetate, ethyl propionate, propyl propionate, butyl propionate, ethyl butanoate, propyl butanoate, butyl butanoate, ethyl lactate, butyl lactate, γ-lactone or δ-lactone or mixtures thereof. A preferred C₃₋₁₂ ester solvent is butyl propionate.

The C₃₋₁₂ ester solvent may be present in 20 wt % or less based on total weight of the ink composition, preferably 10 wt % or less, more preferably 8 wt % or less and even more preferably 6 wt % or less.

The C₃₋₁₂ ester solvent may be present in 0.5 wt % or more based on total weight of the ink composition, preferably 1 wt % or more, or 3 wt % or more.

The C₃₋₁₂ ester solvent may be present in an amount that is in a range with the upper and lower limits selected from the amounts described above. For example, the C₃₋₁₂ ester solvent may be present in the composition between 0.5 to 8 wt %, preferably 1 to 8 wt %, and most preferably 3 to 6 wt % by weight based on total weight of the ink composition.

When the capping resin is a terpene phenolic resin, preferably the C₃₋₁₂ ester solvent is present in in the composition from 0.5 to 6 wt %, preferably from 0.5 to 2.5 wt % based on total weight of the ink composition.

When the capping resin is a rosin resin preferably the C₃₋₁₂ ester solvent is present in the composition from 1 to 8 wt %, preferably from 3 to 6 wt % based on total weight of the ink composition.

In the printed deposit the C₃₋₁₂ ester solvent has at least partially evaporated. In this case, it may be that no C₃₋₁₂ ester solvent or only trace amounts of C₃₋₁₂ ester solvent are present in the printed deposit.

The C₃₋₁₂ ester solvent may have a lower evaporation rate than the C₁₋₆ alcohol solvent.

The C₃₋₁₂ ester solvent has an evaporation rate of less than 1, preferably less than 0.7. The evaporation rate is measured relative to N-butylacetate. The evaporation method may be measured by the ASTM method D3539-87(2004), Standard Test Methods for Evaporation Rates of Volatile Liquids by Shell Thin-Film Evaporometer, ASTM International, West Conshohocken, Pa., 2004.

The C₃₋₁₂ ester solvent may have a higher boiling point than the C₁₋₆ alcohol solvent.

The C₃₋₁₂ ester solvent may have a boiling point of 500° C. or less at 1.0 bar pressure, preferably 400° C. or less, more preferably 300° C. or less and even more preferably 200° C. or less.

The C₃₋₁₂ ester solvent may have a boiling point of 50° C. or more at 1.0 bar pressure, preferably 100° C. or more and more preferably 140° C. or more.

The C₃₋₁₂ ester solvent may have a boiling point in a range with the upper and lower limits selected from the amounts described above. For example, the C₃₋₁₂ ester solvent may have a boiling point between 100 and 200° C. at 1.0 bar pressure.

When the C₃₋₁₂ ester solvent is a mixture the boiling point refers to the individual boiling point of at least one of the C₃₋₁₂ esters in the mixture, preferably, the boiling point refers to the individual boiling point of all of the C₃₋₁₂ esters in the mixture. The term individual boiling point used here refers the boiling point of the solvent measured when the solvent is not in a mixture.

Capping Resin

The ink composition of the present invention comprises a capping resin selected from a rosin resin and a terpene phenolic resin. Preferably the capping resin is hydrophobic.

The term hydrophobic used in the present application refers to a resin whose interactions with oil or other hydrophobic solvents are more thermodynamically favourable than its interactions with water and other polar substances. For example, the hydrophobic resin may be charge neutral or non-polar.

Suitable rosin resins include esters of hydrogenated rosin such as pentaerythritol rosin resins (e.g. Foralyn 110, Pentalyn H-E, Foral 105-E, Permalyn 6110, Permalyn 5110, Pinecrystal KE-359 (Arakawa), Hydrogral P (DRT), Sylvalite RE 100L (Kraton), Sylvalite RE 110L (Kraton), Sylvatac RE 100 (Kraton)) and glycerol ester hydrogenated rosin resins (e.g. Staybelite Ester 10-E, Foralyn 90 or Foralyn 85-E). Preferably, the rosin resin is an ester of hydrogenated rosin such as a pentaerythritol ester of hydrogenated rosin.

Suitable terpene phenolic resins include hydrogenated terpene phenolic resins, and terpene phenolic resins produced by co-polymerisation reactions of terpenes (for example, α-Pinene, β-pinene, and d-limonene) with phenol or bisphenol. By controlling the stoichiometry of the terpenes and phenol, it is possible to engineer a wide variety of resins. Examples of suitable terpene phenolic resins are Dertophene T, Polyster U115 and Polyster UH115. Preferably the ratio of aliphatic hydrogen to aromatic hydrogen in the terpene phenolic resin is 14:1 or more. The ratio of aliphatic hydrogen to aromatic hydrogen may be determined by ¹H-NMR.

Preferably, the capping resin is a solid at 25° C. and 1.0 bar pressure. In some cases the capping resin has a softening point at 1.0 bar pressure of 200° C. or less, more preferably 175° C. or less and even more preferably 150° C. or less.

The capping resin may have a softening point of 50° C. or more at 1.0 bar pressure, preferably 80° C. or more and more preferably 100° C. or more.

The capping resin may have a softening point in a range with the upper and lower limits selected from the amounts described above. For example, the capping resin may have a softening point between 100 and 150° C. at 1.0 bar pressure. The softening point may be determined using standard methods such as ASTM E28-18, Standard Test Methods for Softening Point of Resins Derived from Pine Chemicals and Hydrocarbons, by Ring-and-Ball Apparatus, ASTM International, West Conshohocken, Pa., 2018.

Preferably, the capping resin has a molecular weight, such as a weight average molecular weight (Mw) between 400 and 10,000, more preferably between 500 and 5,000 and even more preferably between 600 and 2,000. Preferably, the capping resin has a molecular weight, such as a weight average molecular weight (Mw) of at least 400, more preferably at least 500 and even more preferably at least 600. Preferably, the capping resin has a molecular weight, such as a weight average molecular weight (Mw) less than 2,000. The capping resin has a molecular weight, such as a weight average molecular weight (Mw) that is in a range with the upper and lower limits selected from the amounts described above.

Preferably, the capping resin has good solubility in the C₃₋₁₂ ester solvent. For example, the solubility of the capping resin in the C₃₋₁₂ ester solvent is from 20 to 100 grams/100 grams at 25° C., preferably from 20 to 80 grams/100 grams at 25° C.

Preferably, the capping resin has poor solubility in the C₁₋₆ alcohol solvent. For example, the solubility of the capping resin in the C₁₋₆ alcohol solvent is less than 10 grams/100 grams at 25° C., preferably less than 5 grams/100 grams at 25° C. and even more preferably less than 1 gram/100 grams at 25° C.

In this way, when the resin assembles at the aperture of the cartridge or printer nozzle, the low boiling point alcohol solvent is not carried by the resin to the air ink interface and so does not evaporate.

Preferably, the capping resin is present at from 0.5 to 10 wt % based on total weight of the ink composition, more preferably from 1.0 to 5.0 wt % and even more preferably from 1.5 to 3 wt %.

Preferably, the capping resin is present in less than 10 wt % based on total weight of the ink composition, more preferably less than 5.0 wt %, and even more preferably less than 3 wt %. Preferably, the capping resin is present in greater than 0.5 wt % based on total weight of the ink composition, preferably greater than 1 wt %, and even more preferably greater than 1.5 wt %. The capping resin may be present in an amount that is in a range with the upper and lower limits selected from the amounts described above.

Siloxane Surfactant

The ink composition of the present invention comprises a siloxane surfactant. A siloxane surfactant is a surfactant having a siloxane functional group (i.e. an Si—O—Si linkage). Preferably, the siloxane surfactant is a polyether modified siloxane surfactant.

The siloxane surfactant may have a random structure, block structures, comb structure or star-like structure. Preferably the siloxane surfactant has a comb structure. The term comb structure refers to a polymer having a main chain with two or more three-way branch points and linear side chains.

Examples of suitable siloxane surfactants are the siloxane surfactant commercially available products BY16-201 and SF8427 manufactured by Dow Corning Toray Co. Ltd.; B YK-331 and BYK-333 manufactured by BYK-Chemie GmbH; and TEGO Glide 410, TEGO Glide 432, TEGO Glide 435, TEGO Glide 440 and TEGO Glide 450 manufactured by Evonik Industries AG.

In this way, the branches of the comb structure may act as a carrier for the capping resin.

Preferably, the siloxane surfactant has a molecular weight, such as a weight average molecular weight (Mw) between 400 and 20,000, and more preferably between 1,000 and 15,000. Preferably, the siloxane surfactant has a molecular weight, such as a weight average molecular weight (Mw) of at least 400, more preferably at least 1,000. Preferably, the siloxane surfactant has a molecular weight, such as a weight average molecular weight (Mw) less than 20,000, more preferably less than 15,000. The siloxane surfactant has a molecular weight, such as a weight average molecular weight (Mw) that is in a range with the upper and lower limits selected from the amounts described above.

Preferably, the siloxane surfactant is present in 4.0 wt % or less based on total weight of the ink composition, more preferably 3.0 wt % or less and even more preferably 1.5 wt % or less. The siloxane surfactant is present in 0.1 wt % or more based on total weight of the ink composition, preferably 0.2 wt % or more, preferably 0.3 wt % or more, preferably 0.5 wt % or more, preferably 0.7 wt % or more, and even more preferably 0.9 wt % or more. Preferably, the siloxane surfactant is present at about 1.0 wt % based on the total weight of the ink composition. The siloxane surfactant may be present in an amount that is in a range with the upper and lower limits selected from the amounts described above. For example, the siloxane surfactant may be present in from 0.1 to 1.5 wt %.

Preferably the siloxane surfactant has a viscosity of about 100 to 3000 mPa·s, more preferably from 200 to 2000 mPa·s, and even more preferably from 300 to 1000 mPa·s, at 25° C. Preferably the siloxane surfactant has a viscosity of less than 3000 mPa·s, more preferably less than 2000 mPa·s and even more preferably less than 1000 mPa·s at 25° C. Preferably the siloxane surfactant has a viscosity of greater than 100 mPa·s, more preferably greater than 200 mPa·s and even more preferably greater than 300 mPa·s, at 25° C. The viscosity of the siloxane surfactant may be in a range with the upper and lower limits selected from the amounts described above. The viscosity of the siloxane surfactant may be measured using a viscometer such as a Brookfield DV-II+ viscometer.

In some cases, a siloxane surfactant is obtained pre-diluted in a solvent. The viscosity of the siloxane surfactant may refer to the viscosity of the pre-diluted solution or to the siloxane surfactant before dilution. Preferably, the viscosity refers to the siloxane surfactant before dilution, i.e. the viscosity is the viscosity of the siloxane surfactant per se.

Colourant

The ink composition may further comprise a colourant, for example a dye or a pigment. The colourant may be fluorescent, phosphorescent or pearlescent.

The dye may be any suitable dye. For example, the dye may be selected from Solvent black 27 (Valifast 3830, Orasol X45), Solvent black 29 (HBDL N36B), Solvent Black 48 (Morfast Black 101), Solvent Yellow 82 (Orasol Yellow 157, Keyfast Spirit Yellow 2GN), Solvent Red 160 (Orasol Red 365), Solvent Red 125 (Orasol red 363), Solvent Orange 11 (Orasol Orange 247), Solvent Blue 136 (Neptun Blue 755), Solvent Red 122 (Keyfast Spirit Red KL, Keyfast Spirit Red BL), Solvent Red 8 (Keyfast Sprit Red 2BK), Solvent Yellow 62 (Keyfast Spirit Yellow 2RLS), Solvent Yellow 83:1 (Savinyl Yellow RLS), Solvent Blue 44 (Savinyl Blue GLS), Solvent Yellow 79 (Savinyl Yellow 2GLS), Solvent Orange 62 (Valifast Orange 3209), Mixture of Solvent Orange 62 and Solvent Yellow 21 (Valifast 3210), Mixture of Solvent Red 8 and Solvent Orange 92 (Valifast Red 3306), Solvent Blue 44 (Valifast Blue 2620).

The pigment may be in the form of a dispersion in the composition. The pigment may be an inorganic, a metallic or an organic pigment.

Preferably the pigment has an average particle size of less than 1 μm. The average particle size referred to here is the Z average particle size calculated using dynamic light scattering. This is the intensity weighted mean hydrodynamic size of the collection of particles.

For example, the inorganic pigment may be selected from titanium oxides such as titanium dioxide and iron oxide produced by known processes, such as contact, furnace, and thermal processes.

For example, the organic pigments may be selected from carbon blacks, azo pigments (including azo lake, insoluble azo pigment, condensed azo pigment, and chelate azo pigment), polycyclic pigments (for example, phthalocyanine, perylene, perinone, anthraquinone, quinacridone, dioxazine, thioindigo, isoindolinone, and quinophthalone pigments), dye-type chelate pigment (for example, basic dye-type chelate pigments and acid dye-type chelate pigment), and aniline black. Carbon blacks may be produced by known processes, such as contact, furnace, and thermal processes.

Preferably, the organic pigment is carbon black. Carbon blacks usable for black inks include carbon blacks manufactured by Mitsubishi Chemical Corporation, for example, No. 2300, No. 900, MCF 88, No. 33, No. 40, No. 45, No. 52, MA 7, MA 8, MA 100, and No. 2200 B; carbon blacks manufactured by Columbian Carbon Co., Ltd., for example, Raven 5750, Raven 5250, Raven 5000, Raven 3500, Raven 1255, and Raven 700; carbon blacks manufactured by Cabot Corporation, for example, Regal 400 R, Regal 330 R, Regal 660 R, Mogul E, Mogul L, Monarch 700, Monarch 800, Monarch 880, Monarch 900, Monarch 1000, Monarch 1100, Monarch 1300, and Monarch 1400; and carbon blacks manufactured by Degussa, for example, Color Black FW 1, Color Black FW 2, Color Black FW 2 V, Color Black FW 18, Color Black FW 200, Color Black S 150, Color Black S 160, Color Black S 170, Printex 35, Printex U, Printex V, Printex 140 U, Special Black 6, Special Black 5, Special Black 4A, and Special Black 4.

Pigments for yellow inks include C.I. Pigment Yellow 1, C.I. Pigment Yellow 2, C.I. Pigment Yellow 3, C.I. Pigment Yellow 12, C.I. Pigment Yellow 13, C.I. Pigment Yellow 14, C.I. Pigment Yellow 16, C.I. Pigment Yellow 17, C.I. Pigment Yellow 73, C.I. Pigment Yellow 74, C.I. Pigment Yellow 75, C.I. Pigment Yellow 83, C.I. Pigment Yellow 93, C.I. Pigment Yellow 95, C.I. Pigment Yellow 97, C.I. Pigment yellow 98, C.I. Pigment Yellow 109, C.I. Pigment Yellow 110, C.I. Pigment Yellow 114, C.I. Pigment Yellow 128, C.I. Pigment Yellow 129, C.I. Pigment yellow 138, C.I. Pigment Yellow 150, C.I. Pigment Yellow 151, C.I. Pigment Yellow 154, C.I. Pigment Yellow 155, C.I. Pigment Yellow 180, C.I. Pigment Yellow 185, and C.I. Pigment Yellow 139.

Pigments for magenta inks include C.I. Pigment Red 5, C.I. Pigment Red 7, C.I. Pigment Red 12, C.I. Pigment Red 48 (Ca), C.I. Pigment Red 48 8 (Mn), C.I. Pigment Red 57 (Ca), C.I. Pigment Red 57: 1, C.I. pigment Red 112, C.I. Pigment Red 122, C.I. Pigment Red 123, C.I. Pigment Red 168, C.I. Pigment Red 184, C.I. Pigment Red 202, C.I. Pigment Red 176, C.I. Pigment Red 254, C.I. Pigment Red 255, C.I. Pigment Red 272, C.I. Pigment Red 254, C.I. Pigment Orange 64, and C.I. Pigment Orange 73.

Pigments for cyan inks include C.I. Pigment Blue 1, C.I. Pigment Blue 2, C.I. Pigment Blue 3, C.I. Pigment Blue 15: 3, C.I. Pigment Blue 15: 34, C.I. Pigment Blue 16, C.I. Pigment Blue 22, C.I. Pigment Blue 60, C.I. Vat Blue 4, C.A. Vat Blue 60, C.I. Pigment Blue 15:2, C.I. Pigment Blue 15:4, C.I. Pigment Green 3, C.I. Pigment Violet 23 and C.I. Pigment Violet 37.

Preferably, the organic pigment is selected from C.I. Pigment Red 176, C.I. Pigment Red 254, C.I. Pigment Red 255, C.I. Pigment Red 272, C.I. Pigment Red 254, C.I. Pigment Orange 64, C.I. Pigment Orange 73, C.I. Pigment Yellow 83, C.I. Pigment Yellow 138, C.I. Pigment Yellow 139, C.I. Pigment Yellow 151, C.I. Pigment Yellow 154, C.I. Pigment Blue 15:2, C.I. Pigment Blue 15:3, C.I. Pigment Blue 15:4, C.I. Pigment Green 3, C.I. Pigment Violet 23 and C.I. Pigment Violet 37.

Preferably the colourant is present in between 1 to 25 wt % based on total weight of the ink composition, more preferably 1.5 to 15 wt %, and most preferably 2 to 6 wt % based on total weight of the ink composition.

Preferably, the colourant is present in less than 25 wt % based on total weight of the ink composition, more preferably less than 15 wt % and even more preferably less than 4 wt %. Preferably, the colourant is present in greater than 1 wt % based on total weight of the ink composition, preferably greater than 1.5 wt %, and even more preferably greater than 2 wt %. The colourant may be present in an amount that is in a range with the upper and lower limits selected from the amounts described above.

Polysorbate Surfactant

The ink composition may further comprise a polysorbate surfactant. A polysorbate surfactant is a surfactant derived from ethoxylated sorbitan esterified with fatty acid. Preferably, the polysorbate surfactant is a polyethylene glycol sorbitan monostearate, a polyoxyethylenesorbitan tristearate, polyoxyethylene sorbitan monopalmitate or a polyoxyethylene sorbitan monooleate.

Without wishing to be bound by theory, it is proposed that the polysorbate surfactant can assemble quickly at the ink air interface and may form a first barrier whilst the siloxane surfactant, capping resin and ester solvent assemble to form the temporary cap.

Preferably, the polysorbate surfactant is present in 4.0 wt % or less based on total weight of the ink composition, more preferably 3.0 wt % or less and even more preferably 1.5 wt % or less. The polysorbate surfactant is present in 0.1 wt % or more based on total weight of the ink composition, preferably 0.2 wt % or more, preferably 0.3 wt % or more, preferably 0.5 wt % or more, preferably 0.7 wt % or more, and even more preferably 0.9 wt % or more. Preferably, the polysorbate surfactant is present at about 1.0 wt % based on the total weight of the ink composition. The polysorbate surfactant may be present in an amount that is in a range with the upper and lower limits selected from the amounts described above. For example, the polysorbate surfactant may be present in from 0.5 to 1.5 wt %.

Preferably, the polysorbate surfactant has a molecular weight, such as a weight average molecular weight (Mw) between 500 and 5,000, more preferably between 1,000 and 3,000 and even more preferably between 1,200 and 2,000. Preferably, the polysorbate surfactant has a molecular weight, such as a weight average molecular weight (Mw) of at least 500, more preferably at least 1,000 and even more preferably at least 1,200. Preferably, the polysorbate surfactant has a molecular weight, such as a weight average molecular weight (Mw) less than 2,000. The polysorbate surfactant has a molecular weight, such as a weight average molecular weight (Mw) that is in a range with the upper and lower limits selected from the amounts described above.

Preferably the polysorbate surfactant has a viscosity of about 100 to 3000 mPa·s, more preferably from 200 to 2000 mPa·s, and even more preferably from 300 to 1000 mPa·s, at 25° C. Preferably the polysorbate surfactant has a viscosity of less than 3000 mPa·s, more preferably less than 2000 mPa·s and even more preferably less than 1000 mPa·s at 25° C. Preferably the polysorbate surfactant has a viscosity of 100 mPa·s or more, more preferably 200 mPa·s or more and even more preferably 300 mPa·s or more, at 25° C. The viscosity of the polysorbate surfactant may be in a range with the upper and lower limits selected from the amounts described above. The viscosity of the polysorbate surfactant may be measured using a viscometer such as a Brookfield DV-II+ viscometer.

In some cases, a polysorbate surfactant is obtained pre-diluted in a solvent. The viscosity of the polysorbate surfactant may refer to the viscosity of the pre-diluted solution or to the polysorbate surfactant before dilution. Preferably, the viscosity refers to the polysorbate surfactant before dilution, i.e. the viscosity is the viscosity of the polysorbate surfactant per se.

Binder

The inkjet ink composition and/or the printed deposit may further comprise a binder. The binder may be referred to as a binder resin. In this case, the binder is different to the capping resin.

The binder may be selected from any suitable binder, for example, suitable binders include polyamide resins, polyurethane resins, acrylic resins, polyvinyl butyral resins, polyesters, phenolic resins, vinyl resins, polystyrene/polyacrylate copolymers, cellulose ethers, cellulose nitrate resins, polymaleic anhydrides, acetal polymers, polystyrene/polybutadiene copolymers, polystyrene/polymethacrylate copolymers, sulfonated polyesters, aldehyde resins, polyhydroxystyrene resins and polyketone resins and mixtures of two or more thereof.

Preferably, the main binder resin is selected from cellulosic resins, acrylic resins, vinyl resins, polyamides, polyesters and polyurethanes. More preferably, the main binder resin is a cellulosic resin. Even more preferably, the cellulosic resin is cellulose acetate butyrate.

Preferably, the binder has a molecular weight, such as a weight average molecular weight (Mw) between 1,500 and 50,000, more preferably between 10,000 and 50,000 and even more preferably between 15,000 and 50,000. Preferably, the binder has a molecular weight, such as a weight average molecular weight (Mw) of at least 1,500, more preferably at least 10,000 and even more preferably at least 15,000. Preferably, the binder has a molecular weight, such as a weight average molecular weight (Mw) less than 50,000. The binder may have a molecular weight, such as a weight average molecular weight (Mw), that is in a range with the upper and lower limits selected from the amounts described above.

Preferably, the binder has good solubility in the organic solvents commonly used in solvent based inks. For example, the solubility of the binder in the solvent is from 20 to 100 grams/100 grams at 25° C.

Preferably, the binder is present at from 1.0 to 25 wt % based on total weight of the ink composition, more preferably from 1.5 to 10 wt % and even more preferably from 4 to 6 wt %.

Preferably, the binder is present in less than 25 wt % based on total weight of the ink composition, more preferably less than 10 wt %, more preferably less than 8 wt % and even more preferably less than 6 wt %. Preferably, the binder is present in greater than 1.0 wt % based on total weight of the ink composition, preferably greater than 1.5 wt %, and even more preferably greater than 4 wt %. The binder may be present in an amount that is in a range with the upper and lower limits selected from the amounts described above.

Preferably, the binder has good solubility in the organic solvents commonly used in solvent based inks.

For example, the solubility of the binder in the solvent is from 20 to 100 grams/100 grams at 25° C.

The binder comprises one or more polymers. One or more polymers of the main binder resin may be crosslinkable by a metal crosslinker where present. The crosslinking occurs via one or more suitable coordinating groups on the polymers of the main binder resin. For example, the polymers of the main binder resin may have one or more of the following coordinating groups which are capable of binding the metal crosslinker; hydroxyl, carboxyl and amino.

The coordinating group content is from 1.0 to 28 wt % based on the total weight of the main binder resin, more preferably the coordinating group content is from 2 to 22 wt % and even more preferably from 3 to 17 wt %. Preferably, the coordinating group content is less than 28 wt % based on the total weight of the main binder resin, more preferably less than 22 wt % and even more preferably less than 17 wt %. Preferably, the coordinating group content is greater than 1.7 wt % based on the total weight of the main binder resin, preferably greater than 2 wt %, and even more preferably greater than 3 wt %. The coordinating group content of the main binder resin may be in a range with the upper and lower limits selected from the amounts described above.

Additionally, the main binder resin may impart desirable viscosity and adhesion properties to the ink.

In one embodiment, the polymers of the main binder resin have hydroxyl groups for coordination with a metal crosslinker.

Preferably the hydroxyl number is from 40 to 330 mg KOH/g, more preferably 50 to 265 mg KOH/g, and most preferably 100 to 200 mg KOH/g. Preferably the hydroxyl number is less than 330 mg KOH/g, more preferably less than 265 mg KOH/g, and most preferably less than 200 mg KOH/g. Preferably the hydroxyl number is greater than 40 mg KOH/g, more preferably greater than 50 mg KOH/g, and preferably greater than 100 mg KOH/g. The hydroxyl number of the main binder resin may be in a range with the upper and lower limits selected from the amounts described above.

The hydroxyl number is the number of milligrams of potassium hydroxide required to neutralize the acetic acid taken up on acetylation of one gram of a chemical substance that contains free hydroxyl groups.

Preferably the hydroxyl content is from 1.0 to 10 wt % based on the total weight of the main binder resin, more preferably the hydroxyl content is from 1.3 to 8 wt % and even more preferably from 2 to 6 wt %. Preferably, the hydroxyl content is less than 10 wt % based on the total weight of the main binder resin, more preferably less than 8 wt % and even more preferably less than 6 wt %. Preferably, the hydroxyl content is greater than 1.0 wt % based on the total weight of the main binder resin, preferably greater than 1.3 wt %, and even more preferably greater than 2 wt %. The hydroxyl number of the main binder resin may be in a range with the upper and lower limits selected from the amounts described above. The hydroxyl content of the binder resin may be an amount that is in a range with the upper and lower limits selected from the amounts described above.

The hydroxyl content expressed in weight percent refers to the weight percent (wt %) of hydroxyl groups in units of the mass of hydroxide functional groups in grams per 100 grams of substance.

Metal Crosslinker

The inkjet ink composition and/or the printed deposit may further comprise a metal crosslinker.

The metal crosslinker contains a metal species that can form a crosslink between polymers of the binder. The metal species of the metal crosslinker may form a crosslink between the polymers of the binder resin where such are present. Any suitable metal species can be used for this purpose.

Preferably the metal crosslinker is a titanium or zirconium containing species, preferably a Ti(IV) or Zr(IV) containing species. A metal crosslinker may be used which in solution reacts to form a cross link between two or more polymers using the metal in the metal crosslinker.

The metal crosslinker may be a metal ligand complex, for example a metal cation with an organic ligand. Preferably the ligand of the metal ligand complex is an organic ligand such as an alkylphosphate. Preferably, the metal of the metal ligand complex is a metal cation, such as Ti(IV) or Zr(IV). For example, the metal crosslinker may be selected from titanium acetylacetonate, titanium butylphosphate, titanium triethanolamine, titanium lactate, zirconium diethylcitrate, zirconium acetate, and zirconium propionate. Preferably, the metal crosslinker is titanium butylphosphate such as Tytan AP100.

Preferably, the metal crosslinker is added in from 0.1 to 5 wt %, more preferably 0.5 to 4 wt %, and most preferably 1.0 to 3.5 wt % based on total weight of the ink composition.

Preferably, the metal crosslinker is added in less than 5 wt % based on total weight of the ink composition, more preferably less than 4 wt % and even more preferably less than 3.5 wt %. Preferably, the metal crosslinker is added in greater than 0.1 wt % based on total weight of the ink composition, preferably greater than 0.5 wt %, and even more preferably greater than 1.0 wt %. The metal crosslinker may be present in an amount that is in a range with the upper and lower limits selected from the amounts described above.

Without wishing to be bound by theory it is believed the metal species crosslinks some of the polymers of the binder by interacting with the polymer through coordinating groups on the polymer. Examples of coordinating groups are hydroxyl, carboxyl and amino.

At least some crosslinking may occur in the liquid ink, however, it is preferable that full crosslinking occurs only when the solvent evaporates. The solvent evaporation increases the concentration of the components and will increase the rate of crosslinking. The temporary cap proposed for the present invention prevents solvent evaporation and so prevents an increase in concentration of the ink components before printing which may reduce the crosslinking that can occur in the liquid ink.

Additives

The ink composition and the printed deposit may contain additional components, such as are common in the art.

Preferably, the ink composition and the printed deposit may further comprise one or more preservatives, humectants, surfactants, plasticisers, conductivity salts, wetting agents, adhesion promotion additives, biocides and mixtures of two or more thereof.

Conductivity Additives

The ink composition and the printed deposit may further comprise a conductivity additive. The conductivity additive may be any organic salt known in the art.

Conductivity additives for ink compositions are well-known in the art, in particular conductivity additives for ink compositions for inkjet inks are well known.

Preferably, the organic salt is selected from quaternary ammonium or phosphonium salts. For example, the organic salt may be selected from tetraethylammonium chloride, tetraethylammonium bromide, tetrabutylammonium chloride, tetrabutylammonium bromide, tetrabutylammonium acetate, tetrabutylammonium nitrate, tetrabutylammonium tetrafluoroborate, tetrabutylammonium hexafluorophosphate, tetrabutylphosphonium chloride and tetrabutylphosphonium bromide. A preferred salt is tetrabutylammonium bromide.

Preferably, the conductivity additive is present at from 0.1 to 5 wt % based on total weight of the ink composition.

Humectants

The ink composition and the printed deposit may further comprise a humectant.

Suitable humectants include ethylene glycol, 1,3-propanediol, 1,4-butanediol, 1,4-cyclohexanedimethanol, 1,5-pentanediol, 1,6-hexanediol, 1,8-octanediol, 1,2-propanediol, 1,2-butanediol, 1,3-butanediol, 2,3-butanediol, diethylene glycol, triethylene glycol, tetraethylene glycol, polyethylene glycol, dipropylene glycol, polypropylene glycol, glycerol, 1,2,6-hexanetriol, sorbitol, 2-pyrrolidone, 2-propanediol, butyrolacetone, tetrahydrofurfuryl alcohol and 1,2,4-butanetriol and mixtures of two or more thereof. Preferably the humectant is selected from a group consisting of glycerol, tetrahydrofurfuryl alcohol, polypropylene glycol and mixtures of two or more thereof.

The ink composition may comprise up to 30% by weight of humectants based on the total weight of the composition. More preferably, the ink composition comprises up to 20% by weight of humectants based on the total weight of the composition.

Preservatives

The ink composition and/or the printed deposit may further comprise a preservative.

Suitable preservatives include sodium benzoate, benzoic acid, sorbic acid, potassium sorbate, calcium sorbate, calcium benzoate, methylparaben and mixtures of two or more thereof. The preferred preservative is sodium benzoate.

The ink composition may comprise up to 2% by weight of preservative based on the total weight of the composition. More preferably, the ink composition comprises up to 1% by weight of preservative based on the total weight of the composition.

Types of Packaging

The present disclosure further provides a method for printing images on a substrate comprising directing a stream of droplets of any of the embodiments of the ink composition of the invention onto a substrate and allowing the ink droplets to dry, thereby printing images on a substrate. An inkjet printer such as a drop on demand inkjet printer or continuous inkjet printer may be used in the method. Preferably, a drop on demand inkjet printer such as a thermal inkjet printer may be used.

Any suitable substrate may be printed in accordance with the invention.

The ink composition of the present invention is particularly suitable for printing on non-porous material, for example, non-porous materials used for food packaging.

Examples of suitable substrates include blister packs (e.g. for medical products such as tablets and the like), electronic components (e.g. batteries), metalized cans, plastic pots, retort pouches, and flexible plastic films. These substrates can be made, for example, from aluminium, steel, glass, polystyrene, PVC, LDPE, HDPE, polypropylene, PET, nylon or PVdC.

Methods and Uses

The ink compositions are formulated by combining the components using methods known in the art.

The components of the ink composition may be combined by adding the components together and stirring using mechanical agitation. In some cases the components may be added in the following order: ester solvent, capping resin, siloxane surfactant, additional additives, and colourant (e.g. pigment dispersion) followed by alcohol solvent.

The present disclosure further provides a method for printing images on a substrate comprising directing a stream of droplets of the ink composition of any of the embodiments to a substrate and allowing the ink droplets to dry, thereby printing images on a substrate. An inkjet printer such as a drop on demand inkjet printer or continuous inkjet printer may be used in the method. Preferably, a drop on demand inkjet printer such as a thermal inkjet printer may be used.

The ink compositions of the present invention are suitable for printing on non-porous substrates.

Any suitable substrate may be printed in accordance with the invention. Examples of substrates that may be printed using the ink composition of the present invention include porous substrates such as uncoated paper, semi-porous substrates such as aqueous coated paper, clay coated paper, silica coated paper, UV overcoated paper, polymer overcoated paper, and varnish overcoated paper, and non-porous substrates such as hard plastics, polymer films, polymer laminates, metals, metal foil laminates, glass, and ceramics. The paper substrates may be thin sheets of paper, rolls of paper, or cardboard. Plastics, laminates, metals, glass, and ceramic substrates may be in any suitable form such as in the form of bottles or containers, plates, rods, cylinders, etc.

Advantageously, using the compositions and methods described herein overcomes and/or mitigates at least some of the problems described above, providing an improved quality print.

### Definitions

As used herein the term printed deposit refers to the ink composition after it has been printed onto a suitable substrate. That is the ink composition of the present invention wherein at least some of the solvent has evaporated.

As used herein the term ink composition includes an inkjet ink composition suitable for use in inkjet printing. The ink composition is typically in the form of a liquid, and typically a solution.

As used herein the term C₁₋₆ alcohol solvent refers to any solvent having at least one hydroxyl function group (—OH) and having from 1 to 6 carbon atoms. The solvent may have a linear, branched or cyclic structure. The solvent may be saturated or unsaturated, preferably the alcohol solvent is at least partially saturated.

As used herein the term C₃₋₁₂ ester solvent refers to any solvent having at least one ester functional group (—OC(═O)—) and having from 3 to 12 carbon atoms. The ester solvent may have a linear, branched or cyclic structure (e.g. lactones). The ester solvent may be saturated or unsaturated, preferably the alcohol solvent is at least partially saturated.

As used herein the term polymer refers to any substance having a repeat unit and includes: saccharides and its derivatives for example cellulose and its derivatives; addition polymers such as acrylic resins or polyvinyl resins; condensation polymer, for example polyurethanes, polyamide and polyesters; and co-polymers wherein the repeat unit is formed of two or more different compounds, for example of styrene and maleic anhydride.

Decap refers to the time that nozzles can be uncovered and idle before they will no longer print. The decap time is the printer idle time after which maintenance will be necessary to regain the print quality. Decap time can also be referred to as “open time”.

Latency refers to the time that nozzles can be left inactive during a print session before there is a significant reduction in initial performance when printing is active. For example latency refers to the time between printing during a print session after which the first few drops are either irregular or are not printed. Often, latency problems produce ragged edges in images and can be referred to as a first drop problem. Latency can also be referred to as “dwell time”.

Other Preferences

Each and every compatible combination of the embodiments described above is explicitly disclosed herein, as if each and every combination was individually and explicitly recited.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

Certain aspects and embodiments of the invention will now be illustrated by way of example and with reference to the figures described above.

### Examples

The following non-limiting examples further illustrate the present invention. All tests were carried out in a 20° C. lab environment at 1.013 kPa with relative humidity ranging from 20% to 50%.

General Methods

Drying Time

To measure dry time, a message was printed using a Domino G series printer, a HP 45Si cartridge and a sample slide on a sheen card substrate for the ink formulation to be tested.

The sheen card substrate was Hiding Power Chart, 301-A, coated supplied by TQC sheen or Melinex. An example message is shown in Error! Reference source not found.1.

Melinex refers to Melinex 339 sheets (175 micron), which is a non-porous white polyester substrate provided by CADILLAC PLASTIC LIMITED

Drying time may be tested at 200×300 dpi or 150×600 dpi.

Using a clean gloved hand, successive crosses were lightly rubbed with a finger immediately after printing the message and then at one second intervals. The test is stopped when the print ceases to smear. The time taken for the print to cease smearing is the drying time.

The test is repeated three times to get an average drying time which is the drying time provided for each formulation below where applicable.

Latency

Latency is defined as the time a cartridge can be left not printing and uncapped without a drop in print quality when printing is re-started.

Latency is tested using 2D data matrix codes like that shown in 3 printed using a Domino G series printer, a HP 45Si cartridge and a sample slide on a one sided 120 mg gloss paper (Splendorlux lightweight) for the ink formulation to be tested.

The cartridge is wiped clean and 3 print samples are taken. This is the starting point 0 hour.

Further print samples are taken after several predetermined intervals—10 minutes, 30 min, 60 min, 90 min, 2 hours and 4 hours. Between prints the cartridge is left uncapped. The quality of the 2D codes is graded with an Axicon 2D bar code grader to the standard PD ISO/IEC TR 29158:2011. Examples for specified characteristics are cell contrast, modulation, reflectance margin, axial and grid nonuniformity, quiet zone, transition ratio and decodability.

A good result for latency is a long latency time (i.e. indicating that the cartridge can be left uncapped for a long time).

### Example 1—Screening of Resins with Pigments

TABLE 1
Resins used in screening

| | | Softening | Molecular | |
|---|---|---|---|---|
| | Chemical nature | point/° C. | weight g/mol | CAS |
| YS Polyster | Terpene phenolic | 115 ± 5 | — | 25359-84-6 |
| U115 | resin | | | |
| Foralyn 110 | Ester of | 101 | <1000 Da | 64365-17-9 |
| | hydrogenated rosin | | | |

All experiments with the resins YS Polyster U115, and Foralyn 110 were based on a varnish given in Table 2. The resin was dissolved with a high-shear rotor-stator mixer into the blend of 1-methoxy-2-propanol and butyl propionate. The ethanol and the CAB binder were added followed by the remaining ingredients.

The resins and their amounts are varied in the experiments as well as the amount of butyl propionate.

TABLE 2
Varnish for resin screening

| Ingredient | Content (wt %) |
|---|---|
| Ethanol | Up to 100 |
| 1-methoxy-2-propanol | 32.94 |
| Butyl propionate | 0-7.5 |
| Resin | 1-2.2 |
| CAB 551-0.01 | 4.35 |
| Tytan AP 100 | 3 |
| Tego Glide 440 | 1 |
| Pigment dispersion | 7.5 |

The amounts of butyl propionate and resins are explained for each example formulation below. The amount of ethanol in each formulation is adjusted to make up the total of 100 wt %.

Ethanol was obtained from Tennants Distribution Limited as Trade Specified Denatured Alcohol. 1-methoxy-2-propanol was obtained from Sigma-Aldrich with a purity specification of >99.5%.

Butyl propionate was obtained from Sigma-Aldrich with a purity specification of >98%.

Resin YS Polyster U115 was obtained as pellets from Yasuhara Chemicals Resin Foralyn 110 was obtained as pellets from Eastman.

CAB 551-0.01 was obtained as powder from Eastman.

Tytan AP 100 was obtained as liquid from Borica.

Tego Glide 440 was obtained from Evonik.

The pigment dispersion contained the ingredients ethanol (as above), EFKA PX 4320, an acrylic block-copolymer based dispersing agent with 50% active ingredient in 2-methoxy-1-methylethyl acetate, obtained from BASF, and the pigment Mogul E, obtained as powder from Cabot. Quantities are given in Table.

TABLE 3
Composition of pigment dispersion

| | Content/wt % |
|---|---|
| Ethanol | 36 |
| EFKA PX 4320 | 24 |
| Mogul E | 40 |

YS Polyster U115

For YS Polyster U115 a range of experiments were performed varying the content of the resin itself as well as the content of butyl propionate.

TABLE 4
Formulation details YS Polyster U115 based on
varnish given in Table 2

| Formulation | YS Polyster U115 | Butyl propionate | |
|---|---|---|---|
| no. | (wt %) | (wt %) | Latency (h) |
| 1 | 1.8 | 5 | <1 |
| 2 | 1 | 5 | <1 |
| 3 | 1 | 2.5 | <1 |
| 4 | 1.8 | 2.5 | 1 h |
| 5 | 1.8 | 1.5 | 1 h |
| 6 | 1.8 | 1 | 2+ |
| 7 | 2 | 1.5 | 2+ |

The experiments show that the resin improves latency in the presence of butyl propionate. Decreasing the amount of YS Polyster U115 from 1.8% to 1% and keeping the amount of butyl propionate the same at 2.5%, the latency drops from 1 hour to below 1 hour. Increasing the amount of YS Polyster U115 from 1.8% to 2% keeping the amount of butyl propionate constant at 1.5%, the latency increases from 1 hour to above 2 hours.

Foralyn 110

A range of experiments was performed using Foralyn 110 as the resin.

TABLE 5
Formulation details using Foralyn 110 based
on varnish given in Table 2

| | Foralyn 110 | Butylpropionate | | Dry time |
|---|---|---|---|---|
| Formulation no. | (wt %) | (wt %) | Latency (h) | (s) |
| 8 | 1.8 | 5 | >2.5 | 2.3 |
| 9 | 1.4 | 5 | 1 to 2 | |
| 10 | 1.4 | 4 | <1 | |

Formulations no 8, 9 and 10 show that both reducing Foralyn 110 and butyl propionate reduce the latency. Dry time was measured for Formulation no. 8 showing fast drying time with long latency time at 200×300 dpi.

### Example 2—Screening of Resins with Dyes

TABLE 6
Capping resins

| | | Softening | |
|---|---|---|---|
| | Chemical nature | point/° C. | CAS |
| Dertophene T | Terpene phenolic | 95 | 25359-84-6 |
| | resin | | |
| YS Polyster | Hydrogenated terpene | 115 ± 5 | 1254557-84-0 |
| UH115 | phenolic resin | | |
| Permalyn ™ | Pentaerythritol ester | 101 | 8050-26-8 |
| 6110 | of rosin | | |

Table 6 gives an overview of the capping resins used in this section. The formulations for each experiment are disclosed below. The resins were dissolved with a high-shear rotor-stator mixer into the blend of 1-methoxy-2-propanol and butyl propionate. The ethanol and the CAB binder were added followed by the remaining ingredients.

TABLE 7
Formulations comprising Permalyn ™ 6110 as capping resin

| | Formulation no. | | | | |
|---|---|---|---|---|---|
| | 11 | 12 | 13 | 14 | 15 |
| Acetone | | 53.35 | | | |
| 1-methoxy-2-propanol | 28 | 28 | 28 | 28 | 28 |
| Butyl propionate | 5 | 5 | 5 | 5 | 5 |
| Permalyn (™) 6110 | 1.8 | 1.8 | 1.8 | | 1.8 |
| CAB 551-0.1 | 4.35 | 4.35 | 4.35 | 4.35 | 4.35 |
| Ethanol (DEB) | 52.35 | | 54.35 | 55.15 | 56.35 |
| Tytan AP100 | 3 | 3 | 3 | 3 | |
| Tego Glide 440 | 1 | 1 | | 1 | 1 |
| Tween 60 | 1 | | | | |
| Valifast Black 3830 | 3.5 | 3.5 | 3.5 | 3.5 | 3.5 |
| Total (% w/w) | 100 | 100 | 100 | 100 | 100 |

The components for these formulations were obtained as in example 1 with the following additions:

Acetone was obtained as Acetone N Grade from Tennants Distribution Limited.

Permalyn™ 6110 was obtained as pellets from Eastman.

Valifast Black 3830 was obtained as powder from Orient.

TABLE 8
Results on dry time and latency of formulations given in Table 7

| | Dry Time | Dry Time | Dry Time | Dry Time | |
|---|---|---|---|---|---|
| Formulation | 200 × 300 dpi | 150 × 600 dpi | 200 × 300 dpi | 150 × 600 | Latency at |
| no. | Sheen | Sheen | Melinex | dpi Melinex | RH <30% |
| 11 | 1 s | 3 s | 2 s | 3 s | 16 hours |
| 12 | 1 s | 2 s | 1 s | 2 s | <10 seconds |
| 13 | 1 s | 2 s | 1 s | 2 s | — |
| 14 | 1 s | 3 s | 2 s | 2 s | — |
| 15 | 1 s | 3 s | 2 s | 2 s | 16 hours |

Table 8 shows the formulations of a series of experiments performed to assess the functionality of different components of the formulation. ‘RH’ refers to relative humidity. All formulations comprise Permalyn™ 6110 as capping resin apart from Formulation no. 14 in which it was removed for comparison. Table 8 summarises the results for dry time (in seconds) at different resolutions and on different substrates as well as for latency testing.

Formulation no. 11 comprises the capping resin, ethanol and 1-methoxy-2-propanol as main solvents, butyl propionate and Tego Glide 440. This formulation gives dry times of 3 sec on all substrates and at all resolutions as well as excellent latency tested up to 16 hours.

Changing the main solvent from ethanol to acetone (Formulation no. 12) improves on dry time, however, only gives a latency of about 10 seconds.

Removing Tego Glide 440 (Formulation no. 13) does not give a high quality initial print, so latency can't be tested. The same is observed when the capping resin is removed (Formulation no. 14). Removing the cross-linker Tytan AP 100 (Formulation no. 15) doesn't have a significant effect on either dry time or latency.

TABLE 9
Formulations comprising Polyster UH115
and Dertophene T as capping resin

| | Formulation no. | |
|---|---|---|
| | 16 | 17 |
| 1-methoxy-2-propanol | 28 | 28 |
| Butyl propionate | 5 | 5 |
| Polyster UH115 | | 1.8 |
| Dertophene T | 1.8 | |
| CAB 553-0.4 | 1.5 | 1.5 |
| Ethanol (DEB) | 58.2 | 57.2 |
| Tytan AP100 | 1 | 1 |
| Tego Glide 440 | 1 | 1 |
| Polysorbate 80 | | 1 |
| Valifast Black 3830 | 3.5 | 3.5 |
| Total (% w/w) | 100 | 100 |

TABLE 10
Results on dry time and latency of formulations given in Table 9

| | Dry | Dry | Dry | Dry | |
|---|---|---|---|---|---|
| | Time | Time | Time | Time | Latency |
| Formulation | 200 × 300 | 150 × 600 | 200 × 300 | 150 × 600 | at RH |
| no. | Sheen | Sheen | Melinex | Melinex | <30% |
| 16 | 1 s | 3 s | 2 s | 3 s | 30 min |
| 17 | 1 s | 3 s | 2 s | 3 s | 16 hours |

Table 9 shows two formulations with different capping resins as well as a different binder and a different polysorbate surfactants. Table 10 summarises the results for dry time (in seconds) at different resolutions and on different substrates as well as for latency testing.

Both formulations show improved latency with good drying times.

### Example 3—Screening Additional Surfactants

For additional surfactant screening, a range of surfactants of different chemical natures (summarised in Table 11) were studied in a formulation as shown in Table 12.

TABLE 11
Surfactants used in screening

| | | Molecular | |
|---|---|---|---|
| | Chemical nature | weight/g/mol | CAS |
| Span 20 | Sorbitan monolaurate | 346.47 | 1338-39-2 |
| Tween 60 | Polyethylene glycol sorbitan | 1,311.7 | 9005-67-8 |
| | monostearate | | |
| Tween 65 | Polyoxyethylenesorbitan | 1,884.6 | 9005-71-4 |
| | Tristearate | | |
| Polysorbate | Polyoxyethylene (80) | 1310 | 9005-65-6 |
| 80 | sorbitan monooleate | | |

TABLE 12
Varnish for surfactant screening

| Ingredient | Content/wt % |
|---|---|
| Ethanol | Up to 100 |
| 1-methoxy-2-propanol | 27.94 |
| Butyl propionate | 5 |
| Propyl acetate | 5 |
| Foralyn 110 | 1.8 |
| CAB 551-0.01 | 4.35 |
| Tytan AP 100 | 3 |
| Tego Glide 440 | 1 |
| Surfactant | 1 |
| Pigment dispersion | 7.5 |

The impact of the surfactants Span 20, Tween 60, Tween 65, and polysorbate 80 on dry time was assessed. The additional surfactants were added at 1% to the formulation in Table 12 containing 5% of the co-solvent propyl acetate. The formulations and results for dry time (in seconds) are summarised in Table 13.

TABLE 13
Impact of surfactants on dry time

| | | Dry time (s) |
|---|---|---|
| Formulation no. | Surfactant | 200 × 300 dpi |
| 18 | Span 20 | 3 |
| 19 | Tween 60 | 2.3 |
| 20 | Tween 65 | 2.7 |
| 21 | Polysorbate 80 | 2 |

### Example 4—Adhesion Properties

Formulation no. 11 from Example 2 was tested for its adhesion properties using a tape test on various substrates (LDPE, HDPE, PP and PET) using two types of tape (3M Scotch Grade 810 and Elocometer ISO 2409).

PP substrates were obtained as 1.5 mm sheets, natural, from Engineering and design plastics.

LDPE substrate were obtained as 1.5 mm sheets, natural, from Engineering and design plastics.

HDPE substrate were obtained as 1.5 mm sheets, natural, from Engineering and design plastics.

PET substrates were obtained as 1.5 mm sheets, Veralite 100, A-PET, from Engineering and design plastics. 3M Scotch Grade 810 adhesive tape was obtained from Lyreco.

Elcometer ISO 2409 adhesive tape was obtained from by Elcometer adhesive tapes.

FIG. 3 shows the test message printed at 200×300 dpi onto PP, LDPE, HDPE and PET from left to right.

The test is performed 24 hours after printing the formulation on the substrate using a Domino G series printer, a HP 45Si cartridge and a sample slide of the substrate to be tested.

The 5 cm segment of the tape be tested, 3M Scotch Grade 810 or Elcometer ISO 2409, was applied to separate printed squares and removed in a swift motion.

The test is repeated on 3 squares for each kind of tape and for each substrate. The tape adhesion properties are visually assessed using the grading system in Table 14.

TABLE 14
Grading system for Tape adhesion of printed samples

| | Very poor | Poor | Moderate | Good | Excellent |
|---|---|---|---|---|---|
| | (1) | (2) | (3) | (4) | (5) |
| % of code being | 80-100 | 60-79 | 40-59 | 20-39 | <20 |
| removed | | | | | |

Table 15 shows the excellent test results for Formulation no. 11 on the specified substrates.

TABLE 15
Tape adhesion results for Formulation no. 11

| | Tape | |
|---|---|---|
| Substrate | 810 | ISO |
| LDPE | Excellent | Excellent |
| HDPE | Excellent | Excellent |
| PP | Moderate | Moderate |
| PET | Excellent | Excellent |

1. An ink composition comprising: a C₁₋₆ alcohol solvent, a C₃₋₁₂ ester solvent, a siloxane surfactant, and a capping resin selected from a rosin resin and a terpene phenolic resin.

2. The ink composition of claim 1 wherein the siloxane surfactant has a random structure, a block structure, a comb structure or a star-like structure.

3. The ink composition of claim 1, wherein the siloxane surfactant is a polyether modified siloxane surfactant.

4. The ink composition of claim 1, wherein the siloxane surfactant is present in from 0.1 to 1.5 wt %.

5. The ink composition of claim 1, wherein the capping resin is hydrophobic.

6. The ink composition of claim 1, wherein the capping resin is selected from esters of hydrogenated rosin such as pentaerythritol rosin resins, glycerol ester hydrogenated rosin resins, hydrogenated terpene phenolic resins, or terpene phenolic resins produced by co-polymerisation of terpenes, such as α-pinene, β-pinene, and d-limonene, with phenol or bisphenol.

7. The ink composition of claim 1, wherein the C₁₋₆ alcohol is present in the composition between 70 to 90 wt % by weight based on total weight of the ink composition.

8. The ink composition of claim 1, wherein the C₁₋₆ alcohol solvent has a boiling point between 60 and 120° C. at 1.0 bar pressure.

9. The ink composition of claim 1, wherein the C₁₋₆ alcohol solvent is a mixture of two or more C₁₋₆ alcohols.

10. The ink composition of claim 1, wherein the C₃₋₁₂ ester solvent is present in the composition between 0.5 to 8 wt % by weight based on total weight of the ink composition.

11. The ink composition of claim 1, wherein the C₃₋₁₂ ester solvent has a boiling point between 100 and 200° C. at 1.0 bar pressure.

12. The ink composition of claim 1, further comprising a polysorbate surfactant.

13. The ink composition of claim 12 wherein the polysorbate surfactant is present in from 0.5 to 1.5 wt % based on the total weight of the ink composition.

14. The ink composition of claim 12 wherein the polysorbate surfactant has a molecular weight, such as a weight average molecular weight (Mw) between 1,200 and 2,000.

15. The ink composition of claim 1, further comprising a binder, such as a cellulosic resin.

16. The ink composition of claim 15 wherein the binder comprises one or more polymers having one or more coordinating groups selected from hydroxyl, carboxyl and amino.

17. The ink composition of claim 1, further comprising a metal crosslinker.

18. A printing method comprising the steps of providing a composition according to claim 1, and depositing the ink composition onto a substrate, and optionally permitting the deposited composition to dry.

19. An ink cartridge comprising a composition according to claim 1.
